(19) United States
(12) Patent Application Publication
(10) Pub. No.: US 2025/0381840 A1
(43) Pub. Date: Dec. 18, 2025

(54) VALVE ASSEMBLY FOR A FUEL TANK

(71) Applicant: Eaton Intelligent Power Limited, Dublin 4 (IE)

(72) Inventors: Daniel Lee Pifer, Chelsea, MI (US); Russell S. Trapp, Dexter, MI (US); Yong Li, Shanghai (CN)

(21) Appl. No.: 19/316,783

(22) Filed: Sep. 2, 2025

Related U.S. Application Data
(63) Continuation of application No. PCT/IB2024/052556, filed on Mar. 15, 2024.
(60) Provisional application No. 63/490,592, filed on Mar. 16, 2023.

(51) Int. Cl. B60K 15/035; F16K 31/20

(52) U.S. Cl. CPC B60K 15/035; F16K 31/20; B60K 2015/03561

(57) ABSTRACT

In one embodiment, a valve assembly for a liquid tank system includes a valve housing and a cover. The valve assembly includes an orifice frame structure defining an orifice in a first shape therethrough, and a ribbon having a movable end. The ribbon is configured to seal or unseal the orifice along a first axis of the orifice when the movable end of the ribbon moves with the float. The orifice is asymmetrical across a second axis perpendicular to the first axis and passing through a middle point of the orifice. A first area of the orifice on a first side of the second axis is smaller than a second area of the orifice on the second side of the second axis. The first area of the orifice is configured to be unsealed earlier than the second area of the orifice by the ribbon.

### PRIORITY

This application claims the benefit under 35 U.S.C. § 365 (c) of International Patent Application No. PCT/IB2024/052556, filed 15 Mar. 2024, which claims the benefit under 35 U.S.C. § 119 (e) of U.S. Provisional Patent Application No. 63/490,592, filed 16 Mar. 2023, which is incorporated by reference herein in its entirety.

### TECHNICAL FIELD

This disclosure relates generally to a fuel tank system, and more particularly to a valve assembly to control vapor in the tank.

### BACKGROUND

Fuel tank valves can function to vent vapors from a fuel tank. Generally, the vapors are vented to a canister that stores the vapors and is periodically purge. Fuel tank valves are configured to prevent liquid fuel in the fuel tank from entering the canister when the vehicle is parked on a grade.

### SUMMARY

This disclosure presents in general a valve assembly configured to allow vapor in a tank system for storing liquid (e.g., fuel) to be vented and to prevent liquid leakage when the liquid level is high. By using the valve assembly to control the vapor in the tank and prevent the liquid leakage, the tank system may provide a number of benefits including, for example but not limited to, allowing the valve to reopen at a high tank pressure and vent the vapor, improving the safety of the tank system.

In one embodiment, a valve assembly for a liquid tank is provided. The valve assembly comprises: a valve housing, a cover coupled to the valve housing, a float and a ribbon. The cover comprises an orifice frame structure defining an orifice in a first shape therethrough. The ribbon comprises a movable end coupled to a float in the valve housing, wherein: the ribbon is configured to seal or unseal the orifice along a first axis of the orifice when the movable end of the ribbon moves with the float, the orifice in the first shape is asymmetrical across a second axis perpendicular to the first axis and passing through a middle point of the orifice, a first area of the orifice on a first side of the second axis is smaller than a second area of the orifice on the second side of the second axis, and the first area of the orifice is configured to be unsealed earlier than the second area of the orifice by the ribbon.

In one embodiment, in the valve assembly, the first area of the orifice may include a first end of the orifice; the second area of the orifice may include a second end of the orifice; and the first end of the orifice may be sharper than the second end of the orifice.

In one embodiment, the first end of the orifice has a first rounded corner with a first radius; the second end of the orifice has a second rounded corner with a second radius; and the first radius is smaller than the second radius.

In one embodiment, the first shape is a water droplet shape, and the first end of orifice is a narrower end of the droplet shape.

In one embodiment, the first shape is a triangular shape, a diamond shape, or a kite shape, and the first end of orifice is a shaper end of the triangular shape, the diamond shape, or the kite shape.

In one embodiment, the orifice in the first shape is symmetrical along the first axis along with the orifice is configured to be sealed or unsealed by the ribbon.

In one embodiment, the float is configured to follow a liquid level in the liquid tank system and to press the ribbon against the orifice to seal the orifice when the liquid level is higher than a first threshold level.

In one embodiment, the float is configured to follow a liquid level in the liquid tank system and to pull the ribbon off the orifice to unseal the orifice when the liquid level is lower than a second threshold level and an inner pressure of the liquid tank system is lower than an opening pressure threshold.

In one embodiment, the first area of the orifice that corresponds to a narrower end of the orifice is configured to first open when the movable end of the ribbon is pulled off the orifice.

In one embodiment, the orifice in the first shape is configured to provide a higher opening pressure threshold for the liquid tank system.

In one embodiment, the orifice frame structure defining the orifice therethrough in the first shape is configured to allow vapors in the liquid tank system to pass through the orifice to a vapor control structure of the liquid tank system when the orifice is unsealed by the ribbon.

In one embodiment, the orifice frame structure defining the orifice therethrough in the first shape is configured to prevent liquid stored in the liquid tank system to pass through the orifice to enter a vapor control structure of the liquid tank system when the orifice is sealed by the ribbon.

In one embodiment, the valve assembly further comprises an inner filter structure located in the orifice and connected to the orifice frame structure through one or more bridging structures, wherein the inner filter structure is configured to prevent a solid object to pass through the orifice when the orifice is unsealed by the ribbon.

In one embodiment, the orifice has a surface facing the ribbon and configured to be sealed or unsealed by the ribbon, and the surface facing the ribbon is an angled surface having a particular angle to a surface of the cover.

In one embodiment, the ribbon is configured to be flexible, and the ribbon further comprises a fixed end couped to a fixed position of the valve housing.

In one embodiment, the ribbon further comprises a second movable end couped to another side of the float through a slack, and the first movable end is configured to be pulled by the float earlier than the second movable end when the float moves down with a liquid level in the tank.

In one embodiment, the ribbon is configured to have a nonuniform thickness, and the ribbon has a second movable end that is not coupled to the float.

In one embodiment, a liquid tank system, comprises: a tank for storing a liquid; a valve assembly coupled to the tank; and a vapor control structure connected to the valve assembly through a conduit, wherein the valve assembly comprises: a valve housing; a cover coupled to the valve housing, comprising an orifice frame structure defining an orifice in a first shape therethrough; and a ribbon comprising: a movable end coupled to a float in the valve housing, wherein: the ribbon is configured to seal and unseal the orifice along a first axis of the orifice when the movable end of the ribbon moves with the float, the orifice in the first shape is asymmetrical across a second axis perpendicular to the first axis and passing through a middle point of the orifice, a first area of the orifice on a first side of the second axis is smaller than a second area of the orifice on the second side of the second axis, and the first area of the orifice corresponds to the movable end of the ribbon.

In one embodiment, a valve assembly for a liquid tank system, comprises: a valve housing; a cover coupled to the valve housing, comprising an orifice frame structure defining an orifice in a first shape therethrough; and a ribbon comprising: a movable end coupled to a float in the valve housing, wherein the ribbon is configured to seal and unseal the orifice along a first axis of the orifice when the movable end of the ribbon moves with the float, the orifice in the first shape has a first end that is shaper than a second end, and the first end of the orifice is configured to be sealed by the movable end of the ribbon.

### BRIEF DESCRIPTION OF THE DRAWINGS

Embodiments in accordance with this disclosure will now be described by reference to the accompanying drawings, in which:

FIG. 1 is a schematic partial cross-sectional side illustration of a valve assembly mounted to a fuel tank, with a vapor control structure (e.g., a canister) cooperating with the valve assembly.

FIGS. 2A-2B illustrate example internal structure of the valve assembly that is used to control the vapor flow and prevent fluid leakage.

FIG. 3A illustrates an example cover with a traditional orifice design having a circular shape.

FIG. 3B illustrates an example cover with an improved orifice design having a water-droplet shape.

FIG. 3C illustrates an example cover with an improved orifice design having a water-droplet shape and an inner filer within the orifice.

FIG. 3D illustrates the example cover in FIG. 3B in a 3D perspective.

### DETAILED DESCRIPTION

Particular embodiments of the inventive subject matter now will be described with reference to the accompanying drawings. This inventive subject matter may, however, be embodied in many different forms and should not be construed as limited to the embodiments set forth herein; rather, these embodiments are provided so that this disclosure will be thorough and complete, and will fully convey the scope of the inventive subject matter to those skilled in the art. Reference will now be made in detail to the examples which are illustrated in the accompanying drawings. Wherever possible, the same reference numbers will be used throughout the drawings to refer to the same or like parts. Directional references such as “top,” “up”, “down”, “right”, and “left” are for ease of reference to the figures and not intended to limit the scope of this disclosure.

This disclosure relates generally to a fuel storage system for vehicles, and more specifically, to devices that enable safe venting of fuel vapors while preventing unintentional leakage of liquid fuel. Features are further disclosed for enabling these devices to perform appropriately under a range of operating conditions, such as over-filling of liquid fuel, vehicles on inclined surfaces, and/or vehicle roll-over.

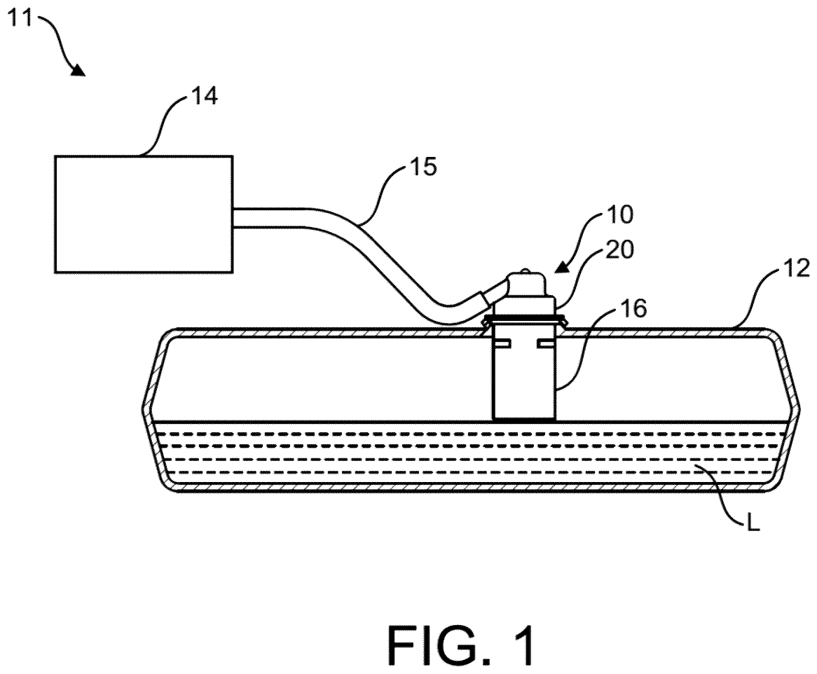

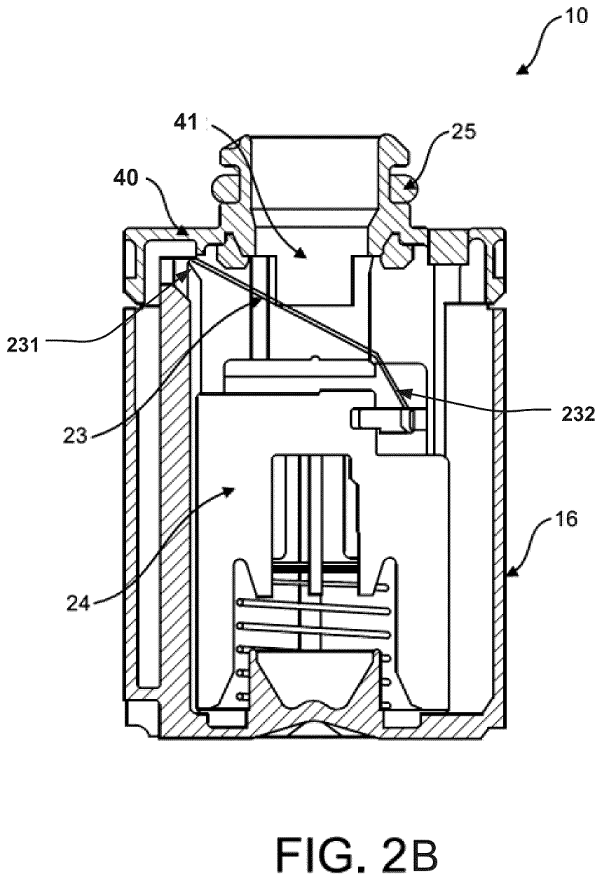

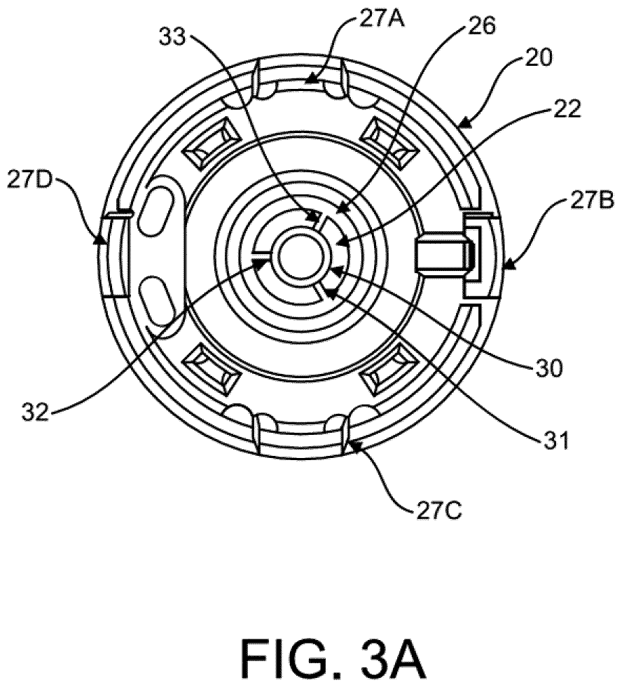

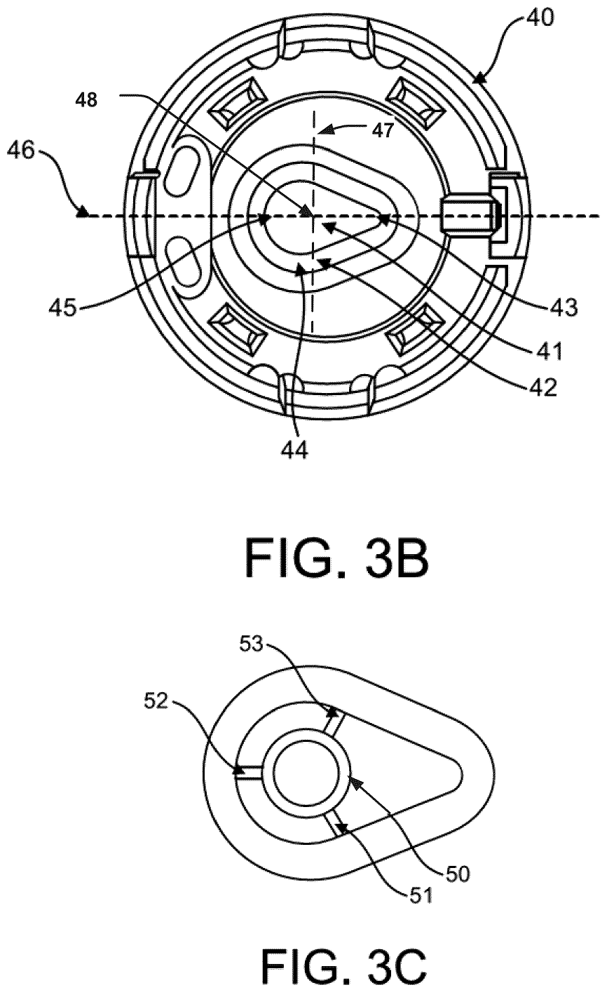

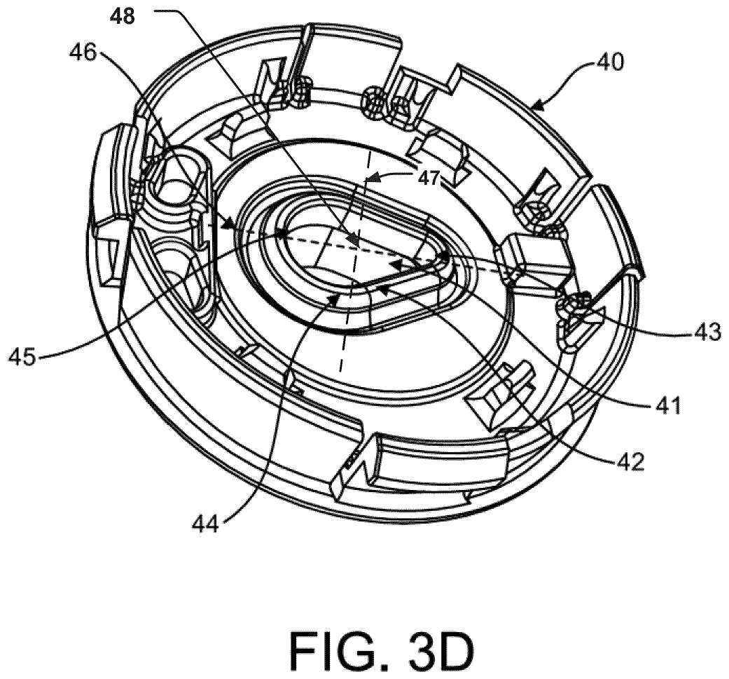

FIG. 1 illustrates an example tank 12 having a valve assembly 10 for control vapor flow and prevent liquid leakage. Referring to the drawings, the like reference numbers may correspond to like or similar components throughout the several figures. In particular embodiments, the tank 12 may be a fuel tank of a vehicle. Therefore, the liquid fluid L stored in the tank 12 may be liquid fuel. The valve assembly 10 may be applied to other types of tanks other than fuel tanks. For example, the valve assembly 10 may be mounted to a urea tank in a vehicle. Therefore, the liquid fluid L stored in the tank 12 may be other types of fluid other than fuel. The valve assembly 10 may be coupled to the tank 12 through one or more mechanical connections. For instance, as shown in FIG. 1, a portion of the valve assembly 10 may be disposed inside the tank 12, and another portion of the valve assembly 10 may be disposed outside the tank 12. The valve assembly 10 may include a cover 20 (as shown in FIG. 3A) directly coupled to the valve housing 16 and may be coupled to the tank 12 by, for example, fusion or adhesive, or any other suitable coupling mechanisms. In particular embodiments, the valve assembly 10 may include a cover 40 (as shown in FIG. 3B) or a cover with other suitable designs for the orifice shape as descripted in this disclosure.

Traditionally, during operation, the vapor may build up in the tank 12 causing a high pressure in the tank 12. Furthermore, other tank operations may also cause a higher pressure in the tank 12. For example, when the tank 12 is being filled with liquid L, the liquid level of the liquid fluid L in the tank 12 may rise to a higher level, resulting in a higher vapor pressure for the vapor above the liquid level. A higher inner pressure in the tank 12 may raise some concerns. To avoid the vapor to build up to a certain level, the valve assembly 10 may allow the vapor to be vented out of the tank 12 to a vapor control structure 14 (e.g., a canister). The valve assembly 10 may have a valve that controls the vapor flow, and the valve may be opened to allow the vapor to be vented out of the tank 12 to the vapor control structure 14 through the valve assembly 10 and the conduit 15.

With the vapor being vented to the vapor control structure 14, the inner pressure of the tank 12 may be reduced to a safety level. The vapor control structure 14 may store the vapor received from the tank and may be periodically purged to keep its own pressure within a safety range. Therefore, when the valve assembly 10 allows the vapor to pass through it (e.g., the valve controlling the vapor flow is open) and the vapor pressure within the tank 12 is higher than the vapor control structure 14, the vapors may flow from the tank 12 into the vapor control structure 14 through the valve assembly 10 and the conduit 15. The conduit 15 may be coupled to the valve assembly 10 through the cover 20. The conduit 15 may be, for example, a hose and can establish fluid and/or vapor communication between the vapor control structure 14 and the valve assembly 10. The vapor control structure 14 may be a canister, such as a charcoal canister. The vapor control structure 14, the valve assembly 10, and the tank 12 may be collectively referred to as a tank assembly 11 (e.g., the fuel tank assembly). The cover 20, the valve housing 16, and the parts (e.g., ribbon, orifice, float, etc.) within the valve housing 16 may be collectively referred to as a valve assembly 10.

In particular embodiments, the valve assembly 10 may close its valve that controls the vapor flow and seal the valve orifice to prevent the liquid leakage from the tank 12. As an example and not by way of limitation, over-filling of liquid fuel, tilting of the fuel tank at a gradient, and/or a vehicle roll-over event may rise the liquid level in the tank 12 to a higher level and the liquid surface may be closer to the valve of the valve assembly 10, resulting in a higher risk of liquid leakage if the valve is open. Thus, the valve assembly 10 may cause its valve closed and sealed to prevent the liquid leakage in such situations.

In particular embodiments, after the valve assembly 10 closed and sealed its valve to prevent liquid leakage, the valve assembly 10 may need to promptly restore the functionality of the vapor release passage through its valve by reopening the valve when the risk of liquid fuel leakage has abated (e.g., the liquid level has fallen under a safety threshold level). As an example and not by way of limitation, following a reduction in the liquid fuel level back to a safe lower level, the vapor release valve of the valve assembly 10 may be opened to release fuel vapors again.

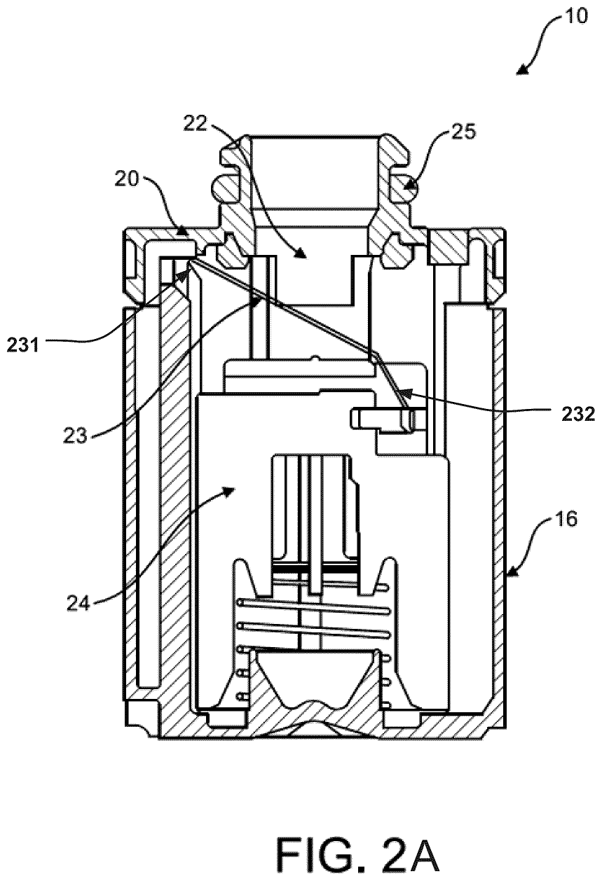

FIGS. 2A-2B illustrate an example internal structure of the valve assembly 10 that is used to control the vapor flow and prevent fluid leakage. The valve assembly 10 may include a cover 20 (as shown in FIG. 2A) or a cover 40 (as shown in FIG. 2B), a valve housing 16, an O-ring 25, a ribbon 23, a float 24, etc. The cover 20 or the cover 40 may be amounted on the top of the valve housing 16 and may be connected to the vapor control structure 14 through the conduit 15 (shown in FIG. 1). The cover 20 and the cover 40 may have different orifice designs. The cover 20 may have a circular orifice 22 as shown in FIG. 3A. The cover 40 may have a water droplet shape orifice 41 as shown in FIG. 3B. The orifice 22 or 41 may be configured to allow the vapor in the tank 12 can pass from the tank 12 to the conduit 15 and the vapor control structure 14 when the orifice 22 or 41 is in open state. The cover 20 or 40 may include an O-ring 25 that is arranged in a slot and used to seal the connection to the conduit 15. Within the valve housing 16, the valve assembly 10 may include a float 24 which may move up and down with the liquid level in the tank 12. The valve assembly 10 may include a ribbon 23 having a first end fixed on a position of the valve assembly 10 and a second end connected to the float 24 and moving with the float 24 in response to the liquid level changes. In this disclosure, it is notable that, except that the cover 20 and 40 have different orifice designs (e.g., a circular orifice for the cover 20 and a water droplet orifice or other improved orifice shapes for the cover 40), other parts of the valve assembly 10 may function in the same or similar way for both the cover 20 and 40 to control the vapor in the tank to be vented and/or to prevent the liquid in the tank to be leaked. In other words, all the operations of the valve assembly 10 related to the cover 20 as described in this disclosure are applicable to the cover 40 in the same or similar way.

When the liquid level is relatively low, the float 24 may have a greater distance to the cover 20. As a result, the movable end of the ribbon 23 may have a greater distance to the cover 20, leaving the orifice 22 in a wide-open state. On the other hand, when the liquid level in the tank 12 is relatively high, the float 24 may have a smaller distance to the cover 20. As a result, the movable end of the ribbon 23 may have a smaller distance to the cover 20, leaving the orifice 22 in a narrow-open state. When the orifice 22 is either in the wide-open state or in the narrow-open state, the vapor in the tank 12 may pass through the orifice 22 of the cover 20 to enter the conduit 15 and the vapor control structure 14, and the valve of the valve assembly 10 is considered as open.

When the liquid level in the tank 12 is higher than a threshold level, the float 24 may move to the top position within the valve housing 16, pressing the ribbon 23 against the cover 20 and sealing the orifice 22 of the cover 20. As a result, the path for the vapor to enter conduit 15 and the vapor control structure 14 may be closed and the orifice 22 of the cover may be sealed. In such situations, the valve assembly 10 is considered having its valve closed. As a result, neither the vapor nor the liquid in the tank 12 can pass through the orifice 22. Such a closing event or sealing event of the orifice 22 may be needed to prevent liquid leakage. As examples and not in a way of limitations, over-filling of liquid fuel, tilting of the fuel tank at a gradient, and/or a vehicle roll-over event may require the valve orifice 22 to be sealed to prevent possible liquid fuel leakage.

In particular embodiments, the ribbon 23 may be used for sealing the valve orifice. When the float 24 rises to the top position, the ribbon 23 may be pressed by the float 24 to abuts the valve orifice of the cover 20 in the housing 16 to seal the orifice 22. In particular embodiments, following a sealing event of the valve orifice 22, the valve assembly 10 may need to promptly restore the functionality of the vapor release passage through the valve orifice 22 by reopening the valve orifice 22 when the risk of liquid fuel leakage has abated. For example, when the liquid level in the tank 12 has fallen under a safety level and the risk of liquid leakage become low, the orifice 22 may need to be reopen promptly to allow the vapor to be vented to the vapor control structure 14 because otherwise the vapor within the tank may build up and increase the inner pressure the tank 12 again. As a non-limiting example, following a reduction in the liquid level back to a safe lower level, the vapor release valve orifice may be promptly opened to allow fuel vapors to be released again. The ribbon 23 that seals the valve orifice 22 may need to promptly open to unseal the orifice 22 and restore the valve orifice 22 to the opening state and allow normal fuel vapor to be vented timely.

In particular embodiments, the design and characteristic of the ribbon 23, the office 22 and the interaction between the ribbon 23, the float, and the valve orifice may control the efficacy and performance of sealing and reopening performance of the valve assembly 10. In particular embodiments, for instance, effective unsealing and reopening of the orifice 22 by the ribbon 23 may rely upon equalizing fluid pressure differences that may exist and hinder reopening operations. For example, when the liquid level in the tank 12 has fallen below a threshold level, the float 24 may be no longer pressed to its highest position in the housing 16. If the pressure within the tank 12 (i.e., the pressure below the ribbon sealing the orifice 22) and the pressure in the vapor control structure 14 (i.e., the pressure above the ribbon 22 sealing the orifice 22) are the same, the float 24 may immediately move down from its highest position and pull the movable end of the ribbon 23 off the orifice 22. However, usually the pressure within the tank 12 may be higher than the pressure in the vapor control structure 14. As a result, the pressure below the ribbon 23 sealing the orifice 22 may be higher than the pressure above the ribbon 23 sealing the orifice 22. Thus, the ribbon 23 may not be able to open immediately when the liquid level has fallen to a lower level. The float 24 and the ribbon 23 may need to overcome the pressure differences below and above the ribbon 23 to unseal the orifice 22. As a result, a particular design of the valve assembly 10 including the design of the orifice 22, ribbon 23, and the float 24 may unseal the orifice 22 under a certain pressure. For example, a traditional ribbon-orifice configuration would reopen at the tank pressure of 15 kPa, which is a relatively low-pressure threshold. Requiring a low tank pressure to reopen the orifice 22 may create some problems.

When the liquid level falls to a lower level, the risk of liquid leakage may be abated and there is no need for the orifice to be sealed anymore. However, because the pressure in the tank may be higher than the tank pressure threshold (15 kPa) for reopening the orifice 22, the orifice 22 may remain being sealed, preventing the vapor in the tank 12 from being vented to the vapor control structure 14 and allowing the inner pressure to further builds up due to the vapor. As such, there is a need for the ribbon 23 and the orifice 22 to reopen earlier at a higher tank pressure level, such as around 45 kPa. Particular embodiments in this disclosure may provide an effective solution to this problem, allowing orifice 22 to be reopened at a higher tank pressure level. Particular embodiments may design the shape of the orifice 22 and the sealing surface between the orifice 22 and the ribbon 23 to make reopening much easier than traditional designs.

FIG. 3A illustrates an example cover 20 with a traditional orifice design having a circular shape. Traditionally, the orifice may be designed to have a circular shape. As an example and not by way of limitation, the cover 20 may have an orifice 22 having a circular shape as defined by the surrounding structure 26 of the orifice 22. The orifice 22 may contain an inner filtering structure 30 to prevent any solid objects (e.g., the ribbon or other object accidently in the tank) from accidently passing through the orifice 22 and entering the conduit 15 and the vapor control structure 14. The inner filtering structure 30 may be connected to the surrounding structure 26 through multiple bridging structures (31, 32, 33). The inner filter structure 30 may allow vapor to pass through but stop any solid objects that accidently get into the tank. The cover 20 may further include multiple coupling mechanisms (27A, 27B, 27C, and 27D) for coupling the cover 20 to the valve housing 16.

As discussed in earlier sections, the ribbon 23 attached to the float 24 would seal the circular orifice 22 when the float rises with the liquid level in the tank 12. When the float lowers, the ribbon 23 would reopen the valve orifice 22. However, with a circular orifice 22, the ribbon may not reopen soon enough at a high tank pressure level, because when the circular orifice 22 is sealed by the ribbon 23, the sealing force may be uniformly distributed along the surrounding structure 26 of the circular orifice 22. To re-open the sealing, the ribbon 23 and the float 24 to which one end of the ribbon 23 is connected to, may need to overcome a greater sealing force between the ribbon 23 and the surrounding structure 26. As a result, the circular orifice 22 may be re-opened only when the tank pressure is much lower (e.g., 15 kPa).

FIG. 3B illustrates an example cover 40 with an improved orifice design having a water-droplet shape. FIG. 3D illustrates the example cover in FIG. 3B in a three-dimensional perspective. In particular embodiments, the cover 40 may be designed to have an orifice in a different shape than the circular shape in the traditional cover 20. The cover 40 may be used in the valve assembly 10 and in the tank system 11, replacing the traditional cover 20. In particular embodiments, the orifice 41 may be designed to have a water-droplet shape, as shown in FIG. 3B. One end of the orifice 41 may be relatively sharper or narrower than the other end 45. In other words, the improved orifice design may have the orifice shape that is non-symmetric along one axis 47 with one end 43 that is narrower than the other end 45. The narrower end 43 and the broader end 45 of the orifice 41 may be on the axis 46 along which the ribbon 23 seals and unseal the orifice 41 when move up and down with the float. In other words, the axis 46 may be parallel to the sealing and unsealing direction of the orifice 41 by the ribbon 23. The orifice 41 may have a middle point 48 which may be the middle point of the narrower and 43 and the broader end 45. A second axis 47 may be perpendicular to the first axis 46 and may pass through the middle point 48. In particular embodiments, the orifice 41 may be optionally symmetrical cross the first axis 46. In particular embodiments, the orifice 41 may the asymmetrical cross the second axis 47. In other words, a first area of the orifice 41 on the first second of the axis 47 may be smaller than a second area of the orifice 41 on the other side of the axis 47. The first area that is smaller may be aligned with the movable end 232 of the ribbon and may be unsealed earlier than the second area which is greater, resulting in an easier unsealing process by the ribbon 23 since the unsealing process starts from a sharper end and the smaller area side of orifice 41.

In particular embodiments, the orifice 41 may have its minimum width at the first end 43. The width may increase along the axis 46 at the positions that are farer from the first end 43 and width may reach its maximum at the position 44. Then, the width may decrease along the axis 46 for the positions that are closer to the other end 45. The overall shape of the orifice 41 may be like a water droplet. The water-droplet shape of the orifice 41 may be defined by the orifice frame structure 42 which is a part of the cover 40. The orifice frame structure 42 may extend out of the surface of the cover 41 for a pre-determined height to allow the orifice frame structure 42 and the ribbon 23 to have a tight sealing surface. The orifice frame structure 42 may be connected to other portion of the cover 40 through a connection portion that is caved in on the inner surface of the cover 40 to improve the structural strength. In particular embodiments, the orifice frame structure 42 may have a surface facing the ribbon and that surface (also referred to as “the surface of the orifice 41”) configured to sealed or unsealed by the ribbon 23 may be a flat surface parallel to the surface of the cover 40. In particular embodiments, the orifice frame structure 42 may have a surface facing the ribbon and that surface (also referred to as “the surface of the orifice 41”) may be an angled surface having a particular angle to the surface of the cover 40. In particular embodiments, the ribbon 23 may be configured to have a thickness less than a threshold thickness to be flexible.

Once installed in the valve assembly 10, the broader end 45 of the orifice 41 may be on the side where the fixed end of the ribbon 23 is located, and the narrower end 43 of the orifice 41 may be on the side where the movable end of the ribbon is located. As a result, when the float 24 moves up to its top position from a lower position while the liquid level increase, the orifice 41 may be sealed by the ribbon 23 gradually from its broader end 45 to its narrower end 43. In particular, during the process of sealing the orifice 41 by the ribbon 23, the broader end 45 may first touch the surface of the ribbon 23. Then, the orifice 41 may be sealed gradually from the broader end 45 to the narrower end 43. On the other hand, when the liquid level drops, the float 24 moves down to a lower position and the opening force is sufficient to overcome the pressure difference below and above the ribbon 23, the orifice 41 may be unsealed gradually starting from its narrower end 43 to its broader end 45.

The width of the orifice 41 having the water droplet shape may have a gradient change along the pulling direction of the ribbon 23 during the unsealing process and may have a relatively narrower width on the end where the unsealing process starts. As a result, because of the water droplet shape of the orifice 41, the ribbon 23 and the float 24 may not need to overcome the pressure difference between the two sides of the ribbon in the sealing state all at once. Instead, the initial opening force that is needed to pull the ribbon 23 off the narrower end 43 of the orifice 41 may be a smaller than the force that is needed to pull the ribbon 23 off the circular orifice 22. Once the narrower end 43 of the orifice 41 has been opened, the vapor in the tank, which has a relative higher pressure, may start to pass through the opened portion of the orifice, resulting in a reduction on the pressure difference between the two sides of the ribbon 23 which makes the later unsealing process easier (i.e., requiring less opening force). As a result, the orifice 41 with the water droplet shape may need a smaller opening force to be opened and may be able to reopen at a relatively higher tank pressure than the circular orifice 22. As an example and not by way of limitation, the orifice 41 with the water droplet shape may be opened at a tank pressure of 45 kPa, which is much higher than the opening pressure of the circular orifice 22 (which is 15 kPa). As a result, the vapor may be able to vent even when the tank pressure is relatively high (e.g., ≤45 kPa), which further improve the safety of the tank system 10. In particular embodiments, the ribbon 23 may have one movable end fixed on a first position of the float 24 and a second movable end (not shown) couped to another side of the float through a slack. Because of the slack on the second movable end, the first movable end may be configured to be pulled by the float earlier than the second movable end when the float moves down with a liquid level in the tank. The movable end coupled to the float 24 may be aligned with the shaper end of the orifice 41. In particular embodiments, the ribbon 23 may be configured to have a nonuniform thickness (i.e., an angled design), and the ribbon may have a second movable end that is free from being coupled to the float (i.e., not coupled to the float). The thicker end of the ribbon may be aligned with the shaper end of orifice 41.

FIG. 3C illustrates an example cover 40 with an improved orifice design having a water-droplet shape and an inner filer within the orifice. The orifice 41 may contain an inner filtering structure 50 to prevent any solid objects (e.g., the ribbon 23 or other objects) from accidently passing through the orifice 41 and entering the conduit 15 and the vapor control structure 14. The inner filter structure 50 may also prevent the ribbon 23 (which is flexible) to be partially sucked into the orifice, causing the orifice to be harder to reopened. The inner filtering structure 50 may be connected to the surrounding structure 26 through multiple bridging structures (51, 52, 53). The inner filter structure 50 may allow vapor to pass through but stop any solid objects that accidently get into the tank.

It is notable that the orifice 41 having the water droplet shape is for example purpose only and the orifice design is not limited thereto. The orifice of the cover may be other shapes, for example but not limited to, a triangular shape, an ellipse shape, a rhombus shape, a trapezoid shape, a pentagon shape, a hexagon shape, an octagon shape, a kite shape, or any other suitable shapes. In particular embodiments, the shape of the orifice design may need to have a relatively narrower width at one end that is on the side where the movable end of the ribbon is located. In particular embodiments, the width of the orifice may have a gradient change along the pulling direction of the ribbon during the unsealing process and may have a relatively narrower width on the end where the unsealing process start, resulting in an easier unsealing process. In particular embodiments, the shape of the orifice may be non-symmetrical along a first direction but symmetrical along a second direction that is perpendicular to the first direction. In particular embodiments, the maximum width of the orifice may be at a middle position or a position that is before or after the middle position.

In particular embodiments, the cover may be designed to have an orifice in a shape as discussed above. The orifice shape may be a different shape other than the circular shape in the traditional cover 20. The cover with the improved orifice shape may be used in the valve assembly 10 and in the tank system 11, replacing the traditional cover 20. By using the improved orifice design, the cover may provide a number of advantages over the cover with the traditional circular orifice. For example, as a result of the improved orifice shape designs, the ribbon and the float may not need to overcome the pressure difference between the two sides of the ribbon in the sealing state all at once. Instead, the initial opening force that is needed to pull the ribbon off the narrower end of the orifice may be a smaller than the force that is needed to pull the ribbon off the circular orifice. Once the narrower end of the orifice has been opened, the vapor in the tank, which may have a relative higher pressure, may start to pass through the opened portion of the orifice, resulting in a reduction on the pressure difference between the two sides of the ribbon which makes the later unsealing process easier (i.e., requiring less opening force). As a result of such orifice design, the orifice may need a smaller opening force to be opened and may be able to reopen at a relatively higher tank pressure than the circular orifice.

The following embodiments can be claimed as well in any combination thereof as indicated by reference back and also in combination with other features described in this disclosure, in particular by replacing the term “embodiment” by the term “claim” to arrive at a corresponding claim set.
Embodiment 1: A valve assembly for a liquid tank system, comprising: a valve housing; a cover coupled to the valve housing, comprising an orifice frame structure defining an orifice in a first shape therethrough; and a ribbon comprising: a movable end coupled to a float in the valve housing, wherein the ribbon is configured to seal or unseal the orifice along a first axis of the orifice when the movable end of the ribbon moves with the float, and wherein: the orifice in the first shape is asymmetrical across a second axis perpendicular to the first axis and passing through a middle point of the orifice, a first area of the orifice on a first side of the second axis is smaller than a second area of the orifice on the second side of the second axis, and the first area of the orifice is configured to be unsealed earlier than the second area of the orifice by the ribbon.
Embodiment 2: The valve assembly of Embodiment 1, wherein: the first area of the orifice includes a first end of the orifice; the second area of the orifice include a second end of the orifice; and the first end of the orifice is sharper than the second end of the orifice.
Embodiment 3: The valve assembly of Embodiment 2, wherein: the first end of the orifice has a first rounded corner with a first radius; the second end of the orifice has a second rounded corner with a second radius; and the first radius is smaller than the second radius.
Embodiment 4: The valve assembly of Embodiment 2 or Embodiment 3, wherein the first shape is a water droplet shape, and wherein the first end of orifice is a narrower end of the droplet shape.
Embodiment 5: The valve assembly of Embodiment 2 or Embodiment 3, wherein the first shape is a triangular shape, a diamond shape, or a kite shape, and wherein the first end of orifice is a shaper end of the triangular shape, the diamond shape, or the kite shape.
Embodiment 6: The valve assembly of any preceding and following embodiments, wherein the orifice in the first shape is symmetrical along the first axis along with the orifice is configured to be sealed or unsealed by the ribbon.
Embodiment 7: The valve assembly of any preceding and following embodiments, wherein the float is configured to follow a liquid level in the liquid tank system and to press the ribbon against the orifice to seal the orifice when the liquid level is higher than a first threshold level.
Embodiment 8: The valve assembly of any preceding and following embodiments, wherein the float is configured to follow a liquid level in the liquid tank system and to pull the ribbon off the orifice to unseal the orifice when the liquid level is lower than a second threshold level and an inner pressure of the liquid tank system is lower than an opening pressure threshold.
Embodiment 9: The valve assembly of any preceding and following embodiments, wherein the first area of the orifice that corresponds to a narrower end of the orifice is configured to first open when the movable end of the ribbon is pulled off the orifice.
Embodiment 10: The valve assembly of any preceding and following embodiments, wherein the orifice in the first shape is configured to provide a higher opening pressure threshold for the liquid tank system.
Embodiment 11: The valve assembly of any proceeding and following embodiments, wherein the orifice frame structure defining the orifice therethrough in the first shape is configured to allow vapors in the liquid tank system to pass through the orifice to a vapor control structure of the liquid tank system when the orifice is unsealed by the ribbon.
Embodiment 12: The valve assembly of any proceeding and following embodiments, wherein the orifice frame structure defining the orifice therethrough in the first shape is configured to prevent liquid stored in the liquid tank system to pass through the orifice to enter a vapor control structure of the liquid tank system when the orifice is sealed by the ribbon.
Embodiment 13: The valve assembly of any proceeding and following embodiments, further comprising an inner filter structure located in the orifice and connected to the orifice frame structure through one or more bridging structures, wherein the inner filter structure is configured to prevent a solid object to pass through the orifice when the orifice is unsealed by the ribbon.
Embodiment 14: The valve assembly of any proceeding embodiments, wherein the orifice has a surface facing the ribbon and configured to be sealed and unsealed by the ribbon, and wherein the surface facing the ribbon is a flat surface parallel to a surface of the cover.
Embodiment 15: The valve assembly of any embodiment of embodiments 1-13, 19 and 20, wherein the orifice has a surface facing the ribbon and configured to be sealed and unsealed by the ribbon, and wherein the surface facing the ribbon is an angled surface having a particular angle to a surface of the cover.
Embodiment 16: The valve assembly of any proceeding and following embodiments, wherein the ribbon is configured to be flexible, and wherein the ribbon further comprises a fixed end couped to a fixed position of the valve housing.
Embodiment 17: The valve assembly of any embodiment of embodiments 1-15, 19, and 20, wherein the ribbon further comprises a second movable end couped to another side of the float through a slack, and wherein the first movable end is configured to be pulled by the float earlier than the second movable end when the float moves down with a liquid level in the tank.
Embodiment 18: The valve assembly of any embodiment of embodiments 1-15, 19 and 20, wherein the ribbon is configured to have a nonuniform thickness, and wherein the ribbon has a second movable end that is not coupled to the float.
Embodiment 19: A liquid tank system, comprising: a tank for storing a liquid; a valve assembly coupled to the tank; and a vapor control structure connected to the valve assembly through a conduit, wherein the valve assembly comprises: a valve housing; a cover coupled to the valve housing, comprising an orifice frame structure defining an orifice in a first shape therethrough; and a ribbon comprising: a movable end coupled to a float in the valve housing, wherein: the ribbon is configured to seal and unseal the orifice along a first axis of the orifice when the movable end of the ribbon moves with the float, the orifice in the first shape is asymmetrical across a second axis perpendicular to the first axis and passing through a middle point of the orifice, a first area of the orifice on a first side of the second axis is smaller than a second area of the orifice on the second side of the second axis, and the first area of the orifice corresponds to the movable end of the ribbon.
Embodiment 20: A valve assembly for a liquid tank system, comprising: a valve housing; a cover coupled to the valve housing, comprising an orifice frame structure defining an orifice in a first shape therethrough; and a ribbon comprising: a movable end coupled to a float in the valve housing, wherein: the ribbon is configured to seal and unseal the orifice along a first axis of the orifice when the movable end of the ribbon moves with the float, the orifice in the first shape has a first end that is shaper than a second end, and the first end of the orifice is configured to be sealed by the movable end of the ribbon.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A valve assembly for a liquid tank system, comprising:
a valve housing;
a cover coupled to the valve housing, comprising an orifice frame structure defining an orifice in a first shape therethrough; and
a ribbon comprising a movable end coupled to a float in the valve housing, wherein:
the ribbon is configured to seal or unseal the orifice along a first axis of the orifice when the movable end of the ribbon moves with the float,
the orifice in the first shape is asymmetrical across a second axis perpendicular to the first axis and passing through a middle point of the orifice,
a first area of the orifice on a first side of the second axis is smaller than a second area of the orifice on a second side of the second axis, and
the first area of the orifice is configured to be unsealed earlier than the second area of the orifice by the ribbon.

2. The valve assembly of claim 1, wherein:
the first area of the orifice includes a first end of the orifice;
the second area of the orifice include a second end of the orifice; and
the first end of the orifice is sharper than the second end of the orifice.

3. The valve assembly of claim 2, wherein:
the first end of the orifice has a first rounded corner with a first radius;
the second end of the orifice has a second rounded corner with a second radius; and
the first radius is smaller than the second radius.

4. The valve assembly of claim 2, wherein the first shape is a water droplet shape, and wherein the first end of orifice is a narrower end of the water droplet shape.

5. The valve assembly of claim 2, wherein the first shape is a triangular shape, a diamond shape, or a kite shape, and wherein the first end of orifice is a shaper end of the triangular shape, the diamond shape, or the kite shape.

6. The valve assembly of claim 1, wherein the orifice in the first shape is symmetrical along the first axis.

7. The valve assembly of claim 1, wherein the float is configured to follow a liquid level in the liquid tank system and to press the ribbon against the orifice to seal the orifice when the liquid level is higher than a first threshold level.

8. The valve assembly of claim 1, wherein the float is configured to follow a liquid level in the liquid tank system and to pull the ribbon off the orifice to unseal the orifice when the liquid level is lower than a second threshold level and an inner pressure of the liquid tank system is lower than an opening pressure threshold.

9. The valve assembly of claim 1, wherein the first area of the orifice that corresponds to a narrower end of the orifice is configured to first open when the movable end of the ribbon is pulled off the orifice.

10. The valve assembly of claim 1, wherein the orifice in the first shape is configured to provide a higher opening pressure threshold for the liquid tank system.

11. The valve assembly of claim 1, wherein the orifice frame structure defining the orifice therethrough in the first shape is configured to allow vapors in the liquid tank system to pass through the orifice to a vapor control structure of the liquid tank system when the orifice is unsealed by the ribbon.

12. The valve assembly of claim 1, wherein the orifice frame structure defining the orifice therethrough in the first shape is configured to prevent liquid stored in the liquid tank system to pass through the orifice to enter a vapor control structure of the liquid tank system when the orifice is sealed by the ribbon.

13. The valve assembly of claim 1, further comprising an inner filter structure located in the orifice and connected to the orifice frame structure through one or more bridging structures, wherein the inner filter structure is configured to prevent a solid object to pass through the orifice when the orifice is unsealed by the ribbon.

14. The valve assembly of claim 1, wherein the orifice has a surface facing the ribbon and configured to be sealed or unsealed by the ribbon, and wherein the surface facing the ribbon is a flat surface parallel to a surface of the cover.

15. The valve assembly of claim 1, wherein the orifice has a surface facing the ribbon and configured to be sealed or unsealed by the ribbon, and wherein the surface facing the ribbon is an angled surface having a particular angle to a surface of the cover.

16. The valve assembly of claim 1, wherein the ribbon is configured to be flexible, and wherein the ribbon further comprises a fixed end coupled to a fixed position of the valve housing.

17. The valve assembly of claim 1, wherein the ribbon further comprises a second movable end coupled to another side of the float through a slack, and wherein the movable end is configured to be pulled by the float earlier than the second movable end when the float moves down with a liquid level in a tank.

18. The valve assembly of claim 1, wherein the ribbon is configured to have a nonuniform thickness, and wherein the ribbon has a second movable end that is not coupled to the float.

19. A liquid tank system, comprising:
a tank for storing a liquid;
a valve assembly coupled to the tank; and
a vapor control structure connected to the valve assembly through a conduit, wherein the valve assembly comprises:
a valve housing;
a cover coupled to the valve housing, comprising an orifice frame structure defining an orifice in a first shape therethrough; and
a ribbon comprising a movable end coupled to a float in the valve housing, wherein:
the ribbon is configured to seal and unseal the orifice along a first axis of the orifice when the movable end of the ribbon moves with the float,
the orifice in the first shape is asymmetrical across a second axis perpendicular to the first axis and passing through a middle point of the orifice,
a first area of the orifice on a first side of the second axis is smaller than a second area of the orifice on a second side of the second axis, and
the first area of the orifice corresponds to the movable end of the ribbon.

20. A valve assembly for a liquid tank, comprising:
a valve housing;
a cover coupled to the valve housing, comprising an orifice frame structure defining an orifice in a first shape therethrough; and
a ribbon comprising:
a movable end coupled to a float in the valve housing, wherein:
the ribbon is configured to seal and unseal the orifice along a first axis of the orifice when the movable end of the ribbon moves with the float,
the orifice in the first shape has a first end that is shaper than a second end, and
the first end of the orifice is configured to be sealed by the movable end of the ribbon.
